(19) United States
(12) Patent Application Publication
(10) Pub. No.: US 2011/0115312 A1
(43) Pub. Date: May 19, 2011

(54) BRUSHLESS DC MOTOR

(76) Inventors: Jong Min YOON, Gyunggi-do (KR); Nak Yun Sung, Gyunggi-do (KR); Yong Ho Won, Seoul (KR)

(21) Appl. No.: 12/730,120

(22) Filed: Mar. 23, 2010

(30) Foreign Application Priority Data
Nov. 16, 2009 (KR) 10-2009-0110487

(51) Int. Cl. H02K 5/167; H02K 1/04

(52) U.S. Cl. 310/43; 310/91

(57) ABSTRACT

Disclosed herein is a brushless DC motor. The brushless DC motor includes a rotating shaft, a bearing, an integrated washer holder, a rotor casing, a stator and a support plate. The bearing rotatably supports the rotating shaft in the radial direction. The integrated washer holder supports the lower end of the rotating shaft and the circumferential outer surface of the bearing. The rotor casing integrally rotates along with the rotating shaft. A rotor magnet is attached to the inner surface of the rotor casing. The stator is provided around the circumferential outer surface of the integrated washer holder such that the stator faces the rotor magnet. Thus, when external electric power is applied to the stator, the rotor casing is rotated by reciprocal action between the stator and the rotor magnet. The integrated washer holder is mounted to the support plate.

### CROSS REFERENCE TO RELATED APPLICATION

This application claims the benefit of Korean Patent Application No. 10-2009-0110487, filed Nov. 16, 2009, entitled “A brushless DC motor”, which is hereby incorporated by reference in its entirety into this application.

### BACKGROUND OF THE INVENTION

1. Technical Field

The present invention relates to a brushless DC motor.

2. Description of the Related Art

Generally, in brushless DC motors for rotating optical recording media, such as optical disks, hard disks, etc., at high speed, an oil film is formed between a bearing and a rotating shaft using a lubricant to rotatably support the rotating shaft, thus ensuring high quality rotational characteristics. Hereby, the brushless DC motors are widely used as a drive means for recording media, such as hard disk drives, optical disk drives, etc., which require high speed rotation.

FIG. 1 is a partial sectional view illustrating a brushless DC motor 10, according to a conventional technique. FIG. 2 is an exploded perspective view showing the construction of a portion of the brushless DC motor 10. Hereinafter, the brushless DC motor 10 according to the conventional technique will be described with reference to FIGS. 1 and 2.

As shown in FIGS. 1 and 2, the brushless DC motor 10 according to the conventional technique includes a rotating shaft 12, a support unit, a rotor casing 28 and a stator 32. In detail, the rotor casing 28 integrally rotates along with the rotating shaft 12 and has a rotor magnet 30 therein. The stator 32 is configured such that a coil 32b is wound around a core 32a to form an electric field using external electric power.

In detail, the support member functions to support not only the rotating shaft 12 but also the entirety of the elements of the brushless DC motor 10. The support unit includes a bearing unit which rotatably supports the rotating shaft 12, and a support part which supports the bearing unit. The bearing unit includes a bearing 16 which supports the rotating shaft 12 in the radial direction, and a thrust washer 18 which supports the rotating shaft 12 in the axial direction. The support part includes a bearing holder 22 which supports the bearing 16, a support disk 24 which supports the thrust washer 18, and a support plate 26 which supports the bearing holder 22. A stopper 20 is provided on the circumferential inner surface of the lower end of the bearing holder 22. The stopper 20 is disposed in a recess 14 which is formed in the rotating shaft 12, thus preventing the rotating shaft 12 from rising up.

The support part is assembled in such a way as to couple the bearing holder 22 made of brass to the support plate 26 through a caulking or spinning process and then couple the support disk 24 made of a steel plate to the bearing holder 22.

However, because the brushless DC motor 10 according to the conventional technique has a large number of elements including the thrush washer 18, the bearing holder 22, the support disk 24 and the support plate 26, the assembly process is complicated, and the assembly cost is thereby increased. In particular, when coupling the bearing holder 22 to the support plate 26 or coupling the support disk 24 to the bearing holder 22 through the caulking or spinning process, plastic deformation of the elements may be induced, thus resulting in a defective product. If a defective product occurs, because it cannot be reproduced, paying a separate disposal cost is required.

Furthermore, because the bearing holder 22 is made of brass and the support disk 24 and the support plate 26 are made of steel, the material cost and the machining cost are increased, and it runs counter to the trend calling for reducing the weight of the product.

### SUMMARY OF THE INVENTION

The present invention has been made in an effort to provide a brushless DC motor which has a simple structure and is able to reduce the costs of the materials and their assembly.

In a brushless DC motor according to an embodiment of the present invention, a rotating shaft is provided. A bearing rotatably supports the rotating shaft in a radial direction. An integrated washer holder supports a lower end of the rotating shaft and a circumferential outer surface of the bearing. A rotor casing integrally rotates along with the rotating shaft. A rotor magnet is attached to an inner surface of the rotor casing. A stator is provided around a circumferential outer surface of the integrated washer holder such that the stator faces the rotor magnet, so that when external electric power is applied to the stator, the rotor casing is rotated by reciprocal action between the stator and the rotor magnet. A support plate supports the integrated washer holder.

The integrated washer holder may be formed by injection molding.

The integrated washer holder may be made of EMC (epoxy molding compound).

The integrated washer holder may include a disk part supporting the lower end of the rotating shaft. An annular support part may be bent upwards from the disk part. The annular support part supports the circumferential outer surface of the bearing. A flange part may be provided around a circumferential outer surface of the annular support part. The flange part has a stepped shape to form a seating surface onto which the stator is seated.

The flange part may have a stepped portion on a lower end thereof, so that the support plate is fitted over the stepped portion of the flange part.

Furthermore, a recess may be formed in a circumferential outer surface of the lower end of the rotating shaft. A stopper may be integrally provided on a circumferential inner surface of the integrated washer holder. The stopper is disposed in the recess.

In addition, an attractive magnet may be provided on an upper surface of the stator to prevent the rotor casing from rising up.

As well, a stop protrusion may be integrally provided on the integrated washer holder. A stop hook may be provided under a lower surface of the rotor casing. The stop hook engages with the stop protrusion.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view illustrating a brushless DC motor, according to a conventional technique;

FIG. 2 is an exploded perspective view showing the construction of a portion of the conventional brushless DC motor of FIG. 1;

FIG. 3 is a sectional view illustrating a brushless DC motor, according to a first embodiment of the present invention;

FIG. 4 is a partially broken perspective view of the brushless DC motor of FIG. 3;

FIG. 5 is a perspective view showing an integrated washer holder of the brushless DC motor of FIG. 3; and

FIG. 6 is a sectional view illustrating a brushless DC motor, according to a second embodiment of the present invention.

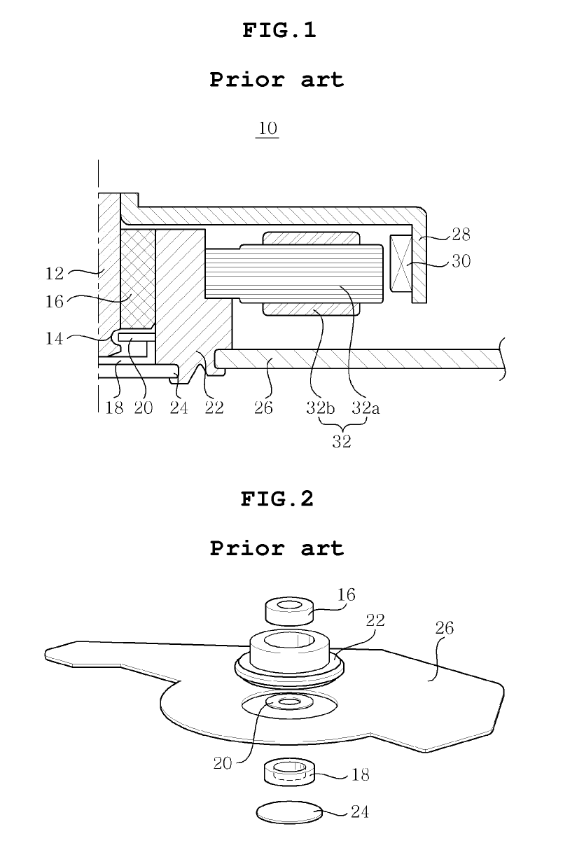

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, the terms and words used in the specification and claims are not necessarily limited to typical or dictionary meanings, but must be understood to indicate concepts selected by the inventor as the best method of illustrating the present invention, and must be interpreted as having had their meanings and concepts adapted to the scope and sprit of the present invention so that the technology of the present invention could be better understood.

Hereinafter, embodiments of the present invention will be described in detail with reference to the attached drawings.

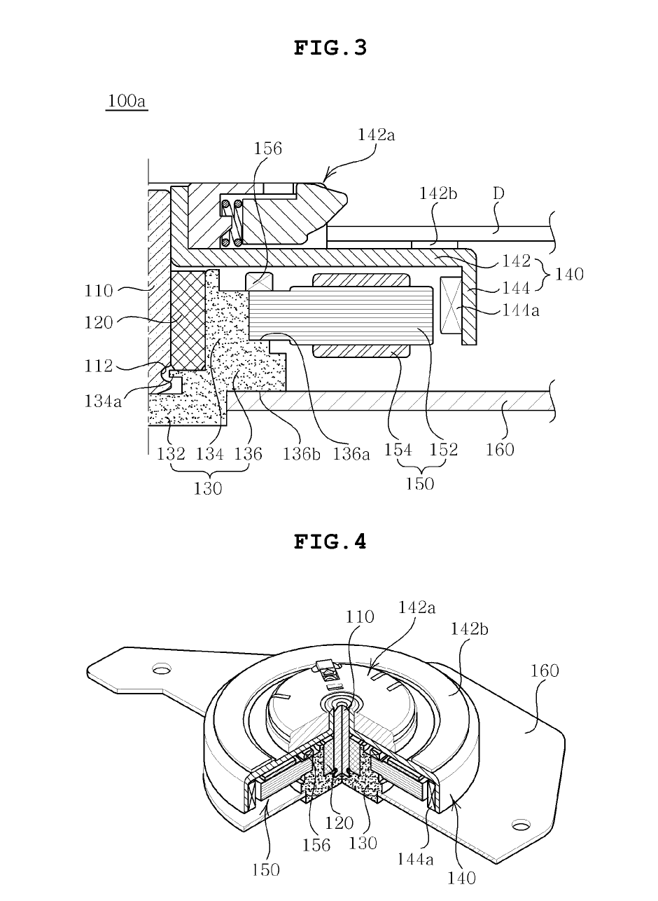

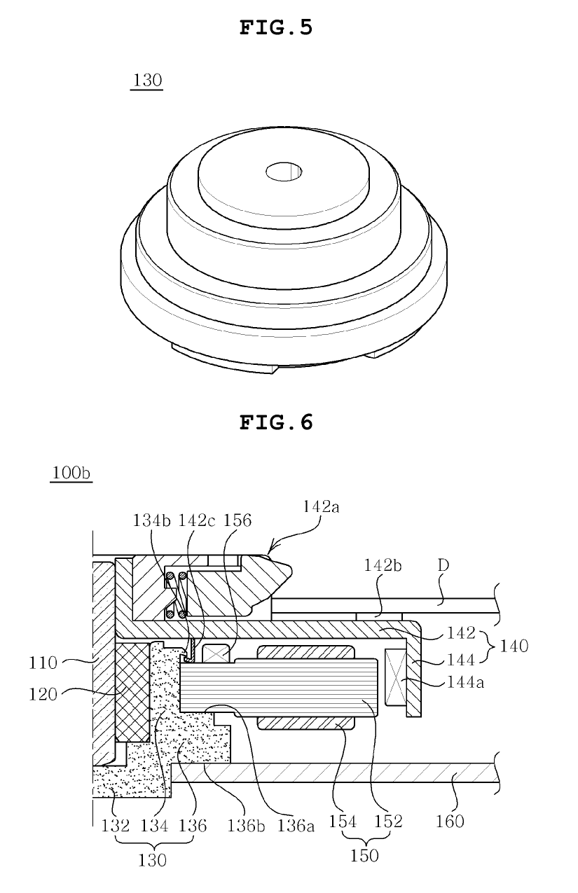

FIG. 3 is a sectional view illustrating a brushless DC motor 100a, according to a first embodiment of the present invention. FIG. 4 is a partially broken perspective view of the brushless DC motor 100a. FIG. 5 is a perspective view showing an integrated washer holder 130 of the brushless DC motor 100a. Below, the brushless DC motor 100a according to the first embodiment of the present invention will be explained with reference to these drawings.

As shown in FIGS. 3 through 5, the brushless DC motor 100a according to the first embodiment includes a rotating shaft 110, a bearing 120, an integrated washer holder 130, a rotor casing 140, a stator 150 and a support plate 160.

The rotating shaft 110 has a cylindrical shape having a predetermined diameter. The rotating shaft 110 is rotated by electromagnetic force which is generated by reciprocal action between a rotor magnet 144a and the stator 150. Here, the rotating shaft 110 integrally rotates along with the rotor casing 140 which is fitted over the upper end of the rotating shaft 110.

The bearing 120 supports the rotating shaft 110 in the radial direction. The bearing 120 has a hollow cylindrical shape, which has therein a hollow space into which the rotating shaft 110 is inserted. In addition, the bearing 120 rotatably supports the rotating shaft 110 using fluid interposed between the bearing 120 and the rotating shaft 110.

The washer holder 130 has an integrated structure and supports the lower end of the rotating shaft 110 and the circumferential outer surface of the bearing 120. That is, the integrated washer holder 130 is configured such that parts corresponding to the thrust washer, the support and the bearing holder of the conventional technique are integrated with each other. The integrated structure of the washer holder 130 can simplify the structure of the motor and the manufacturing process and reduce the weight thereof. Furthermore, corresponding elements of the brushless DC motor can be prevented from deforming during the manufacturing process.

In the embodiment, the integrated washer holder 130 is formed by injection molding using a material, such as plastic, which enables the washer holder 130 to be integrally formed and is able to rotatably support the lower end of the rotating shaft 110. For example, the integrated washer holder 130 is made of an EMC (epoxy molding compound).

In detail, the integrated washer holder 130 includes a disk part 132, an annular support part 134 and a flange part 136. The disk part 132 rotatably supports the lower end of the rotating shaft 110. The annular support part 134 extends upwards from the perimeter of the disk part 132 and supports the circumferential outer surface of the bearing 120. The flange part 136 is provided around the circumferential outer surface of the annular support part 134. The flange part 136 has a stepped shape to form a seating surface 136a onto which the stator 150 is seated. Furthermore, the flange part 136 has on a lower end thereof a stepped portion 136b to which the support plate 160 is coupled.

In addition, a stopper 134a is integrally provided on the circumferential inner surface of the integrated washer holder 130. The stopper 134a is disposed in a recess 112 which is formed in the rotating shaft 110, thus preventing the rotating shaft 110 from rising up. As such, the washer holder 130 forms an integrated structure which includes even the stopper 134a.

The rotor casing 140 is fitted at the central portion thereof over the rotating shaft 110 and thus rotates along with the rotating shaft 110. In the embodiment, the rotor casing 140 includes a disk part 142 which is fitted at the central portion thereof over the rotating shaft 110 and extends outwards from the rotating shaft 110 in the radial direction, and an annular rim part 144 which is bent downwards from the periphery of the disk part 142. The rotor magnet 144a is mounted to the circumferential inner surface of the annular rim part 144. The rotor casing 140 having the above-mentioned structure can be formed through a bending process using a press.

Furthermore, a chucking assembly 142a for chucking a disk D placed onto the rotor casing 140 is provided on the central portion of the upper surface of the disk part 142. A slip prevention member 142b is provided on the perimeter of the upper surface of the disk part 142 to prevent the disk D from slipping with respect to the rotor casing 140. Although the disk D is illustrated as being placed onto the rotor casing 140 in the drawings, a separate turntable for mounting a disk may be provided. This must also be regarded as falling within the bounds of the present invention.

The rotor magnet 144a which is mounted to the circumferential inner surface of the annular rim part 144 generates electromagnetic force using reciprocal action between it and the stator 150. In detail, the rotor magnet 144a has an annular structure such that magnetic poles are alternately magnetized with respect to the circumferential direction to generate force for rotating the rotor casing 140 using reciprocal action between the rotor magnet 144a and the stator 150.

The stator 150 functions to form an electric field using external electric power. The stator 150 includes a core 152 and a coil 154 which is wound around the core 152. When current is applied to the coil 154, armature magnetic flux is excited by the current. The armature magnetic flux is interlinked with magnetic flux generated by the rotor magnet 144a, thus generating torque by which the rotor casing 140 is rotated.

In the embodiment, the stator 150 is fitted over the circumferential outer surface of the integrated washer holder 130 and, in detail, seated onto the seating surface 136a which is formed by the flange part 136.

Furthermore, an attractive magnet 156 is provided on the core 152 to prevent the rotor casing 140 from rising up using magnetic attractive force between it and the disk part 142 of the rotor casing 140. In the drawings, although the attractive magnet 156 is illustrated as being provided on the core 152, it may be provided under the disk part 142 such that the rotor casing 140 is prevented from rising up by magnetic attractive force between the attractive magnet 156 and the stator 150.

The support plate 160 supports the entirety of the elements of the brushless DC motor. The brushless DC motor is mounted to a device, such as a hard disk drive, etc., through the support plate 160. The integrated washer holder 130 is fastened to the support plate 160.

In detail, the support plate 160 is coupled to the stepped portion 136b which is horizontally formed under the lower end of the flange part 136 of the integrated washer holder 130. Hereby, the support plate 160 supports the integrated washer holder 130.

Moreover, a circuit board (not shown) to which electronic devices, such as an encoder, a connector, a passive device, etc., are mounted is coupled on the support plate 160.

FIG. 6 is a sectional view illustrating a brushless DC motor 100b, according to a second embodiment of the present invention. Hereinafter, the brushless DC motor 100b according to the second embodiment of the present invention will be explained in detail with reference to FIG. 6. In the following description of the second embodiment, the same reference numerals will be used to designate the components corresponding to those of the first embodiment, and the explanation of the overlapped portions will be omitted.

As shown in FIG. 6, the brushless DC motor 100b according to the second embodiment of the present invention does not have a separate stopper, unlike that of the first embodiment. In the second embodiment, to provide a structure for preventing a rotor casing 140 from rising up, a stop protrusion 134b is integrally provided around the circumferential outer surface of the upper end of an integrated washer holder 130, and a stop hook 142c which engages with the stop protrusion 134b is provided under a disk part 142 of the rotor casing 140. Here, the stop protrusion 134b can also be integrally formed with the washer holder 130 during a process of forming the washer holder 130 through an injection molding process using plastic.

As described above, in a brushless DC motor of the present invention, a washer holder has an integrated structure such that parts corresponding to the thrust washer, the support and the bearing holder of the conventional technique are integrated with each other. Hence, the structure of the brushless DC motor and the manufacturing process thereof are simplified, thus reducing the assembly cost. As well, because the integrated washer holder is made of plastic, the weight of the brushless DC motor can be reduced, and the material cost can also be reduced.

Moreover, the brushless DC motor according to the present invention is configured such that a stopper or a stop protrusion is integrated with the washer holder. Thus, the structure of the brushless DC motor and the manufacturing process thereof are further simplified, thus further reducing the assembly cost.

Although the embodiments of the present invention have been disclosed for illustrative purposes, it will be appreciated that the brushless DC motor of the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A brushless DC motor, comprising:
a rotating shaft;
a bearing rotatably supporting the rotating shaft in a radial direction;
an integrated washer holder supporting a lower end of the rotating shaft and a circumferential outer surface of the bearing;
a rotor casing to integrally rotate along with the rotating shaft, with a rotor magnet attached to an inner surface of the rotor casing;
a stator provided around a circumferential outer surface of the integrated washer holder such that the stator faces the rotor magnet, so that when external electric power is applied to the stator, the rotor casing is rotated by reciprocal action between the stator and the rotor magnet; and
a support plate to which the integrated washer holder is mounted.

2. The brushless DC motor as set forth in claim 1, wherein the integrated washer holder is formed by injection molding.

3. The brushless DC motor as set forth in claim 1, wherein the integrated washer holder is made of EMC (epoxy molding compound).

4. The brushless DC motor as set forth in claim 1, wherein the integrated washer holder comprises:
a disk part supporting the lower end of the rotating shaft;
an annular support part bent upwards from the disk part, the annular support part supporting the circumferential outer surface of the bearing; and
a flange part provided around a circumferential outer surface of the annular support part, the flange part having a stepped shape to form a seating surface onto which the stator is seated.

5. The brushless DC motor as set forth in claim 4, wherein the flange part has a stepped portion on a lower end thereof, so that the support plate is fitted over the stepped portion of the flange part.

6. The brushless DC motor as set forth in claim 1, wherein a recess is formed in a circumferential outer surface of the lower end of the rotating shaft, and a stopper is integrally provided on a circumferential inner surface of the integrated washer holder, the stopper being disposed in the recess.

7. The brushless DC motor as set forth in claim 1, wherein an attractive magnet is provided on an upper surface of the stator to prevent the rotor casing from rising up.

8. The brushless DC motor as set forth in claim 1, wherein a stop protrusion is integrally provided on the integrated washer holder, and a stop hook is provided under a lower surface of the rotor casing, the stop hook engaging with the stop protrusion.
